(19) United States
(12) Patent Application Publication
(10) Pub. No.: US 2008/0259302 A1
(43) Pub. Date: Oct. 23, 2008

(54) EXPOSURE APPARATUS AND METHOD OF MANUFACTURING DEVICE

(75) Inventors: Yuji Kojima, Tokyo (JP); Ariyoshi Tsuchiya, Tokyo (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/104,562

(22) Filed: Apr. 17, 2008

(30) Foreign Application Priority Data
Apr. 20, 2007 (JP) 2007-112298

(51) Int. Cl. G03B 27/42

(52) U.S. Cl. 355/53; 355/77

(57) ABSTRACT

This invention discloses an exposure apparatus for exposing a substrate to radiant energy in accordance with a recipe including a plurality of elements, the apparatus comprising: a first storage configured to store the plurality of elements; a first processor configured to change a content of a first element stored in the first storage; and a second processor configured to change a content of a second element stored in the first storage, the second element referring to the first element, in accordance with the change performed for the first element.

### BACKGROUND OF THE INVENTION

1. Field of the Invention

The present invention relates to an exposure apparatus which exposes a substrate to radiant energy in accordance with a recipe, and a method of manufacturing a device using the exposure apparatus.

2. Description of the Related Art

A semiconductor element, a liquid crystal display element, an image sensing element (e.g., a CCD (Charge Coupled Device)), a thin-film magnetic head, and other devices are manufactured by various substrate processes using a substrate processing apparatus. Examples of the substrate processes by the substrate processing apparatus are a thin film formation process, a photolithography process, an impurity diffusion process, and a process of inspecting/evaluating a circuit formed on a substrate by these processes.

The photolithography process often uses an exposure apparatus as a type of substrate processing apparatus to perform a process of exposing a shot region on a substrate coated with a photosensitive agent to radiant energy by projecting the pattern of a mask onto the shot region by a projection optical system. In this exposure process, the operator or someone creates in advance a setting file called a recipe which records the exposure processing procedure and exposure parameters. The exposure apparatus reads the recipe and performs an exposure process in accordance with the recipe.

The recipe generally includes a large number of elements such as a mask to be used, a shot layout to be projected onto a wafer, and an alignment mark for use in wafer alignment. SEMI (Semiconductor Equipment and Materials International) proposes standard E139. Standard E139 defines a concept for automatic recipe management called RaP (Recipe and Parameter Management). The concept specifies, for example, the following details.

(1) A recipe and each recipe element are formed from a unit called PDEs (Process Definition Elements).

(2) If a recipe is formed from a plurality of elements, it is expressed by the hierarchical structure of PDEs.

(3) Each PDE has a unique identifier called uid.

(4) Each PDE has a version number for configuration management.

Japanese Patent Laid-Open No. 2006-186254 discloses a method of combining one or a plurality of recipe elements. Each element is expressed by the hierarchical structure of a combination of further detailed elements. Examples of the recipe elements are mask information, substrate information, shot information, shot layout information, alignment mark information, an alignment mark measurement condition, exposure correction process data, and exposure means data. To easily change a recipe and each recipe element which are expressed by a hierarchical structure as described above, Japanese Patent Laid-Open No. 2002-373836 closes a method of displaying the hierarchical structure of the recipe in a tree structure and changing each displayed element.

According to the contents of the above-mentioned SEMI standard E139 and the invention disclosed in Japanese Patent Laid-Open No. 2006-186254, there is provided a means for expressing a recipe as the hierarchical structure of elements. Also, according to the invention disclosed in Japanese Patent Laid-Open No. 2002-373836, there is provided a means for easily changing each element of a recipe with a hierarchical structure and the hierarchical structure itself of the recipe. SEMI standard E139 assigns version numbers to a recipe and PDEs as recipe elements to appropriately manage changes in PDEs.

However, when recipe elements form a hierarchical structure, and the hierarchical structure is implemented as the reference relation between the elements, change in the content of a certain element has an influence on all elements which refer to the certain element. Therefore, when the content of a certain element is changed, all elements which refer to the certain element must be changed. Recipe editing upon this change requires a tremendous load.

### SUMMARY OF THE INVENTION

It is an exemplary object of the present invention to provide an exposure apparatus which reduces the load of recipe editing upon change of an element.

According to the present invention, there is provided an exposure apparatus for exposing a substrate to radiant energy in accordance with a recipe including a plurality of elements, the apparatus comprises:
a first storage configured to store the plurality of elements;
a first processor configured to change a content of a first element stored in the first storage; and
a second processor configured to change a content of a second element stored in the first storage, the second element referring to the first element, in accordance with the change performed for the first element.

According to the present invention, it is possible to provide an exposure apparatus which reduces the load of recipe editing upon change of, for example, an element.

Further features of the present invention will become apparent from the following description of exemplary embodiments with reference to the attached drawings.

### BRIEF DESCRIPTION OF THE DRAWINGS

FIG. 1 is a block diagram showing the configuration of a recipe management system according to the first embodiment;

FIG. 2 is a table showing an example of elements stored in a first storage 1;

FIG. 3 is a table showing an example of the histories of changes stored in a second storage 2;

FIG. 4 is a flowchart illustrating a referred element change process by a first processor 3;

FIG. 5 is a flowchart illustrating a referring element change process by a second processor 4;

FIG. 6 is a flowchart illustrating a change reflecting process by the second processor 4;

FIG. 7 is a block diagram showing the configuration of a recipe management system according to the second embodiment;

FIG. 8 is a diagram showing an example of a change history screen displayed by a display 5;

FIG. 9 is a diagram showing an example of an entry change screen displayed by a first processor 3;

FIG. 10 is a flowchart illustrating a display switching process by a display switching unit 6; and

FIG. 11 is a schematic view for explaining an exposure apparatus.

### DESCRIPTION OF THE EMBODIMENTS

### First Embodiment of Recipe Management

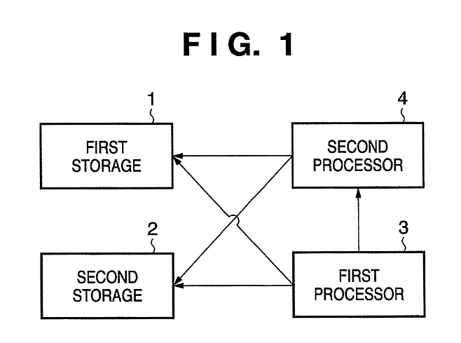

FIG. 1 shows the configuration of a recipe management system according to the first embodiment in an exposure apparatus which executes an exposure process in accordance with a recipe including a plurality of elements.

The exposure apparatus comprises a first storage 1, second storage 2, first processor 3, and second processor 4. The first storage 1 stores the plurality of recipe elements. The second storage 2 stores the history of changes of each element stored in the first storage 1. The first processor 3 changes the content of an element stored in the first storage 1, and the history of changes of the element stored in the second storage 2. The second processor 4 changes an element, which is stored in the first storage 1 and which refers to the element which is stored in the first storage 1 and changed by the first processor 3, in accordance with the change. The second processor 4 further changes the history of changes, stored in the second storage 2, of each element which refers to the element whose history of changes is changed by the first processor 3, in accordance with the change. Although the exposure apparatus according to this embodiment has the second storage 2, the second storage 2 can be omitted. In this case, the first processor 3 requires no function of changing the history of changes of an element stored in the second storage 2. Also, the second processor 4 requires no function of changing the history of changes, stored in the second storage 2, of each element which refers to an element whose history of changes is changed by the first processor 3, in accordance with the change.

The contents of the elements stored in the first storage 1, the histories of changes of the elements stored in the second storage 2, an element change process by the first processor 3, and an element change process by the second processor 4 will be explained in detail in turn below.

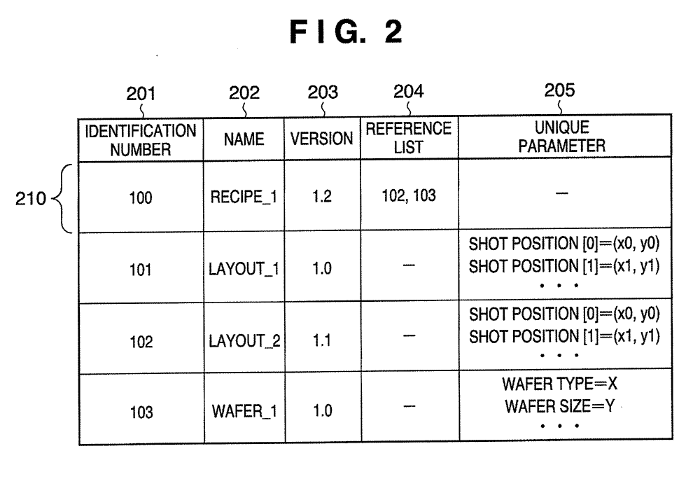

FIG. 2 shows an example of the contents of the elements stored in the first storage 1. Assuming a recipe and its elements as one entry, the first storage 1 stores an arbitrary number of entries. A recipe and its elements stored in the first storage 1 will be referred to “entries” hereinafter. Each entry includes, for example, an identification number 201 which allows unique entry identification, an entry name 202, a version 203, a reference list 204, and a unique parameter 205. The reference list 204 stores a list of identification numbers of entries referred to by an entry of interest. The unique parameter 205 stores parameters unique to each entry in a unique data structure. An entry 210, for example, has an identification number 100 and a name “RECIPE_1”, and refers to elements having identification numbers 102 and 103. For the sake of simple explanation of an embodiment according to the present invention, the element information shown in FIG. 2 includes only the minimum necessary items.

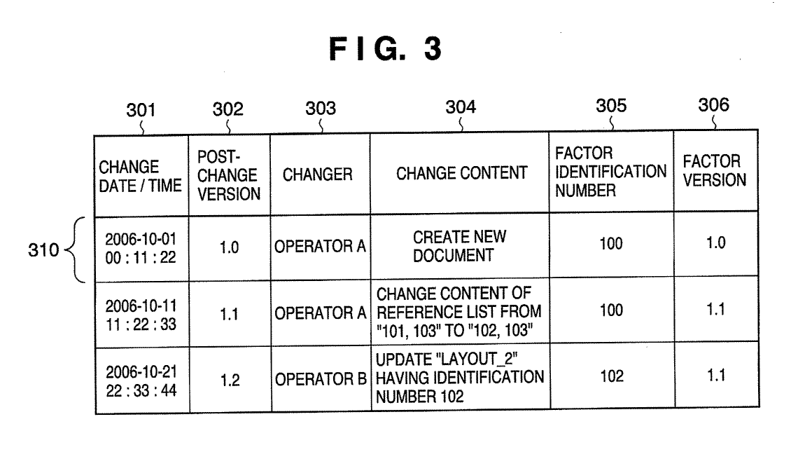

The second storage 2 stores information on the history of changes of each entry stored in the first storage 1. FIG. 3 shows an example of data associated with the history of changes of the entry 210 shown in FIG. 2. The history change data includes data such as a change date/time 301, post-change version 302, changer 303, and change content 304 to be managed by a general configuration management means, and a factor identification number 305 and factor version 306. The factor identification number 305 is the identification number of an entry which has triggered the change. The factor version 306 is the post-change version of an element which has triggered the change. The factor identification number 305 and factor version 306 will be explained in detail in an element change process and referring element change process (to be described later).

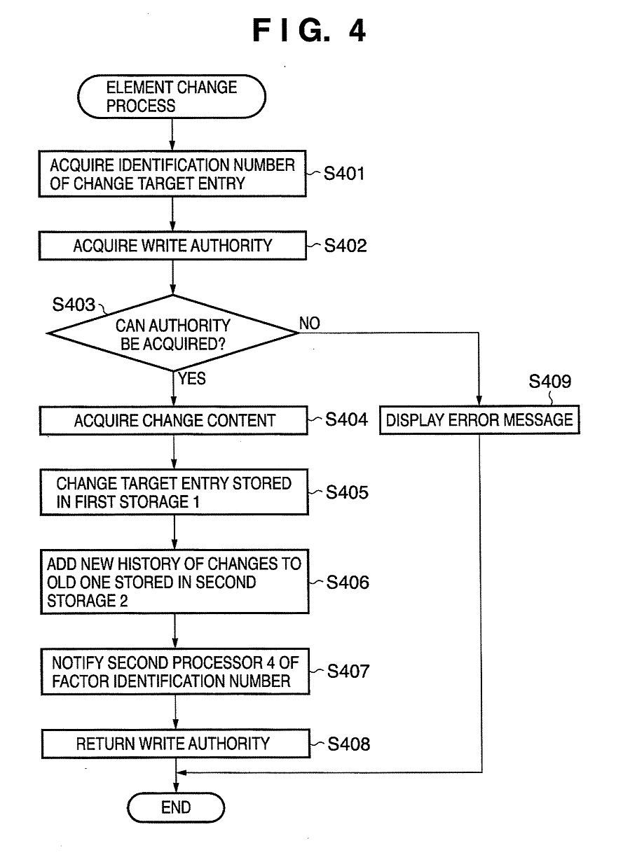

The first processor 3 changes the content of an element stored in the first storage 1 and the history of changes of the element stored in the second storage 2 by an element change process. The procedure of the element change process by the first processor 3 will be explained with reference to the flowchart illustrated in FIG. 4. In step S401, the first processor 3 acquires the identification number of a change target entry. In step S402, the first processor 3 acquires authority to write in the first storage 1 and second storage 2. Note that the first processor 3 is not simultaneously given the write authority for more than one process. If the first processor 3 cannot obtain the write authority in step S403, the first processor 3 displays an appropriate error message in step S409. The element change process is then ended. On the other hand, if the first processor 3 can obtain the write authority in step S403, it acquires the change content of the target entry in step S404. In step S405, the first processor 3 changes, in accordance with the acquired change content, the target entry of an element stored in the first storage 1. At the same time, the first processor 3 increments the version 203. Likewise, in step S406, the first processor 3 adds a new history of changes to the old one of the target entry stored in the second storage 2. In the added history of changes, the change date/time 301 is the change execution time, the post-change version 302 is the version 203 incremented in step S405, and the changer 303 is the user which has performed the change process. Also in the added history of changes, the change content 304 is the change content acquired in step S404, the factor identification number 305 is the identification number obtained in step S401, and the factor version 306 is the post-change version 302. The element change process defines the factor identification number 305 in the history of changes as the identification number of a change target entry, thereby expressing that the content of the target entry itself has been changed. Subsequently, to process the influence of the change in target entry on other entries, the first processor 3 notifies the second processor 4 of the factor identification number 305 in step S407. In step S408, the first processor 3 returns the authority to write in the target entry after waiting until the second processor 4 ends the process. The element change process is then ended.

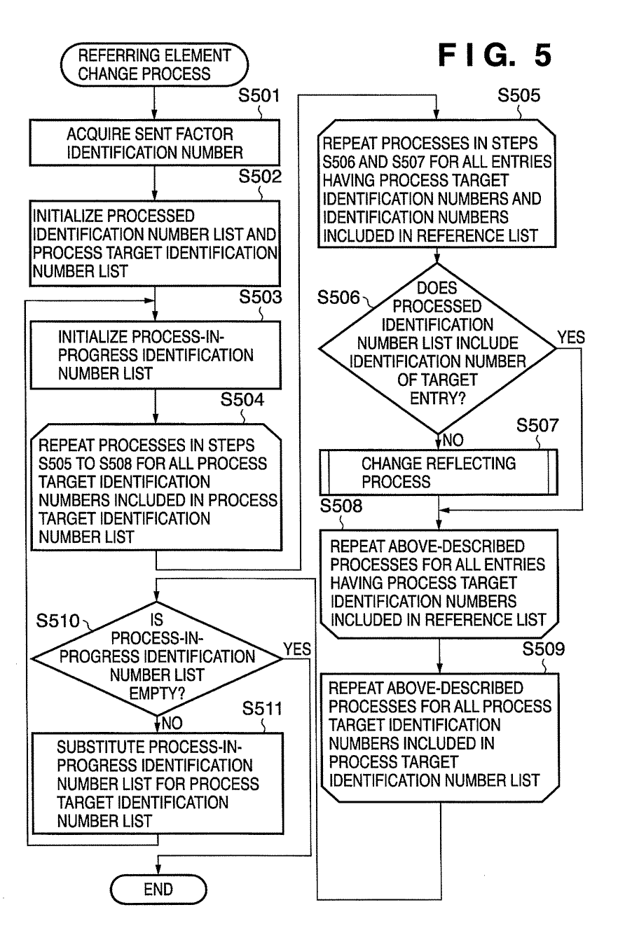

Upon receiving the notification of the factor identification number from the first processor 3, the second processor 4 performs a referring element change process for reflecting, in all entries, the influence of change in an entry specified by a factor identification number. FIG. 5 is a flowchart illustrating the change process by the second processor 4. In step S501, the second processor 4 acquires the factor identification number sent from the first processor 3. In step S502, the second processor 4 creates a processed identification number list and process target identification number list including factor identification numbers alone. The processed identification number list stores the identification numbers of entries in which the influence of the change by the first processor 3 has been reflected, and is used to prevent the same entry from repeatedly undergoing the reflecting process. The process target identification number list stores the identification numbers of entries to consider the influence of the change. In step S503, the second processor 4 creates a list of process-in-progress identification numbers having zero elements. The process-in-progress identification number list stores the identification numbers of entries in which the influence of the change is newly reflected, and is used to pass the influence of the change up to the upper class of a hierarchical structure based on a reference relation.

In step S504, the second processor 4 repeats processes in steps S505 to S508 for all the process target identification numbers included in the process target identification number list. In step S505, the second processor 4 repeats processes in steps S506 and S507 for all entries having process target identification numbers and identification numbers included in the reference list 204. In step S506, the second processor 4 confirms whether the identification number of the target entry is included in the processed identification number list. If the identification number of the target entry is included in that list, the influence of the change by the first processor 3 has already been reflected in the target entry. The second processor 4 advances to step S508 to process the next entry without processing the current entry. On the other hand, if the identification number of the target entry is not included in that list, the change is reflected in the target entry by the change reflecting process in step S507. The identification number of the target entry is then added to the process-in-progress identification number list and the processed identification number list. Details of the change reflecting process will be described later. After the change reflecting process is ended, the second processor 4 advances to step S508 to process the next entry. After the repetition process in step S504 is ended, the change is reflected in an entry which directly refers to the identification number included in the process target identification number list.

In step S510, the second processor 4 confirms whether the process-in-progress identification number list is empty. If the process-in-progress identification number list is not empty, an entry to consider the influence of the change still remains. In step S511, the second processor 4 substitutes the process-in-progress identification number list for the process target identification number list. The second processor 4 then returns to step S503 to continue the process. On the other hand, if it is determined in step S510 that the process-in-progress identification number list is empty, the influence of the change in target entry by the first processor 3 has been reflected in all the entries. The second processor 4 then ends the referring element change process. The second processor changes, first, a referring element which directly refers to an element changed by the first processor, and changes, next, an element which further refers to the referring element.

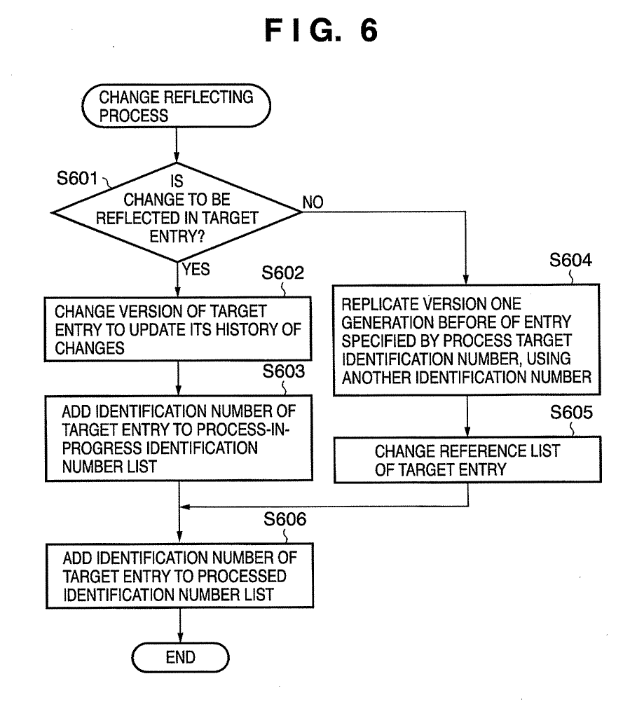

The change reflecting process by the second processor 4 will be explained with reference to the flowchart illustrated in FIG. 6. The change reflecting process is performed as a referring element change process of step S507 to reflect the influence of change in an entry (to be referred to as a factor entry hereinafter) specified by a process target identification number in a target entry. In step S601, the second processor 4 confirms whether to reflect the change content of the factor entry in the target entry. If “YES” in step S601, the second processor 4 advances to step S602. In step S602, the version 203 of the target entry stored in the first storage 1 is incremented to add a new history of changes to the old one of the target entry stored in the second storage 2. The change date/time of the factor entry is added to the change date/time 301. The version 203 incremented in step S602 is added to the post-change version 302. The name of the user which has changed the factor entry is added to the changer 303. The change content of the factor entry is added to the change content 304. The identification number of the factor entry is added to the factor identification number 305. The version 203 of the factor entry is added to the factor version 306. Using the identification number of the factor entry added to the factor identification number 305, it can be expressed that the target entry is indirectly changed by changing the entry that the target entry refers to. Since the version of the target entry is changed in step S602, it is necessary to consider the influence of the change even on an entry which refers to the target entry. For this purpose, in step S603, the second processor 4 adds the identification number of the target entry to the process-in-progress identification number list, and advances to step S606. On the other hand, if “NO” in step S601, in step S604 the second processor 4 replicates the version one generation before of the entry specified by the process target identification number, using another identification number. The change process in step S604 is performed only once for an identical process target identification number. In step S605, the second processor 4 deletes the process target identification number from the reference list 204 of the target entry stored in the first storage 1, adds the identification number of the replicated new entry to the reference list 204 in step S604, and advances to step S606. In step S606, the second processor 4 adds the identification number of the target entry to the processed identification number list. The change reflecting process is then ended.

As has been described above, according to the first embodiment, when the first processor 3 changes an entry stored in the first storage 1, the second processor 4 appropriately processes the influence of the change on other entries which refer to the changed entry. Hence, an exposure apparatus which attains high-precision configuration management is provided.

### Second Embodiment of Recipe Management

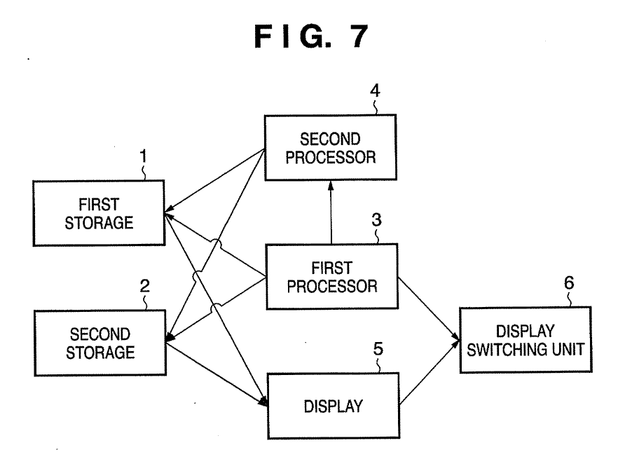

FIG. 7 is a block diagram showing the configuration of a recipe management system according to the second embodiment. An exposure apparatus according to the second embodiment further comprises a display 5 and display switching unit 6, in addition to the configuration according to the first embodiment. The display 5 can display the history of changes of a specific element together with the reference relation between the specific element and other elements and the histories of changes of the other elements in a tree structure. A first storage 1 stores the reference relation. A second storage 2 stores the history of changes. The display 5 can provide a change process screen for changing the content and the history of changes of an element by a first processor 3. The display switching unit 6 switches between the change process screen and a screen for displaying the history of changes in a tree structure.

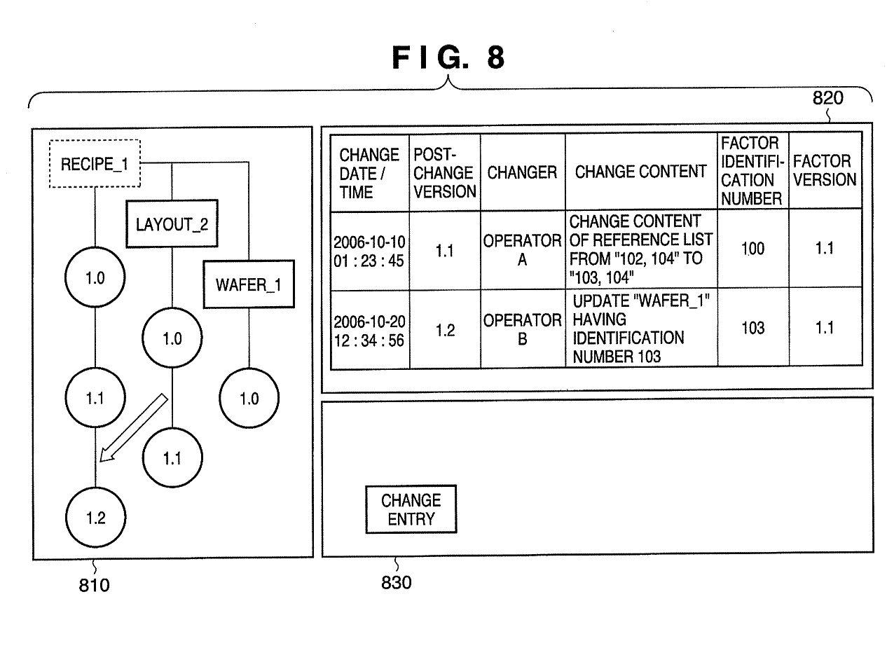

FIG. 8 shows an example of the screen for displaying the history of changes in a tree structure by the display 5. The screen for displaying the history of changes in a tree structure includes a tree display portion 810, detailed history display portion 820, and operation button display portion 830.

The tree display portion 810 reflects that a reference list 204 of an entry having an identification number 100 includes identification numbers 102 and 103 in the elements shown in FIG. 2. Names 202 of these three identification numbers are “RECIPE_1”, “LAYOUT_2”, and “WAFER_1”. The tree display portion 810 displays the “RECIPE_1”, “LAYOUT_2”, and “WAFER_1” entries in a tree structure.

In the history of changes of the entry having an identification number 100 stored in the second storage 2 (FIG. 3), the entry having an identification number 100 has three versions 1.0 to 1.2. The tree display portion 810 displays versions “1.0”, “1.1”, and “1.2” in a tree structure for the “RECIPE_1” entry. For the “LAYOUT_2” and “WAFER_1” entries, the tree display portion 810 similarly displays corresponding versions in a tree structure.

Also in the history of changes shown in FIG. 3, a factor identification number 305 and factor version 306 corresponding to change in version from 1.1 to 1.2 of the entry having an identification number 100 are 102 and 1.1, respectively. The version of the entry having an identification number 100 is indirectly changed from 1.1 to 1.2 by changing an entry that this entry refers to. The tree display portion 810 displays an arrow indicating that the entry having an identification number 100 is indirectly changed by changing an entry that this entry refers to. That is, the display 5 classifies changes in the content of a specific element into changes attributed to a change in the content of the specific element itself by the first processor 3, and those attributed to a change in the contents of other elements by a second processor 4, and displays them as such. The operator can select entries displayed in the tree display portion 810 using, for example, a pointing device, and the currently selected “RECIPE_1” entry is highlighted.

The detailed history display portion 820 acquires, from the second storage 2, change history data of the “RECIPE_1” entry currently being selected in the tree display portion 810, and displays the data.

The operation button display portion 830 displays a “Change Entry” button 831. When the operator presses the “Change Entry” button, a display switching process (to be described later) is notified of the identification number of the entry currently being selected in the tree display portion 810.

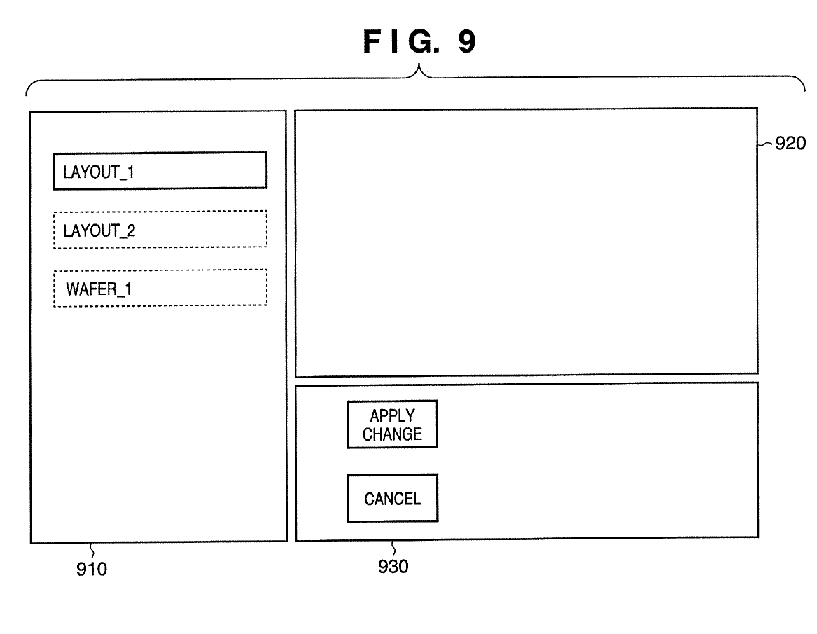

FIG. 9 shows an example of an entry change screen (change process screen) displayed when the first processor 3 is to change the entry having an identification number 100. The entry change screen includes an entry list display portion 910, parameter display portion 920, and operation button display portion 930.

The entry list display portion 910 displays a list of all entries other than the change target “RECIPE_1” entry based on the elements stored in the first storage 1. As is obvious from the elements shown in FIG. 2, the first storage 1 stores the three entries, that is, the “LAYOUT_1”, “LAYOUT_2”, and “WAFER_1” entries in addition to the change target entry. The entry list display portion 910 displays names “LAYOUT_1”, “LAYOUT_2”, and “WAFER_1” of these three entries. The operator can select a plurality of entries to be displayed, and the currently selected “LAYOUT_2” and “WAFER_1” entries are highlighted. The entry list display portion 910 may perform tree display based on the reference list 204 of each entry.

The parameter display portion 920 displays a change input field for a unique parameter 205 of the change target entry. Since the entry having an identification number 100 does not have the unique parameter 205, nothing is displayed in the parameter display portion 920 shown in FIG. 9. The unique parameter 205 can take an entry-specific data structure. Therefore, the parameter display portion 920 may change the layout of the unique parameter 205 in accordance with its data structure.

The operation button display portion 930 displays an “Apply Change” button and “Cancel” button. When the operator presses the “Apply Change” button, the first processor 3 is notified of the change content and identification number of the change target entry in the entry list display portion 910 and parameter display portion 920 so that the first processor 3 performs an element change process. After the element change process is ended, a display switching process (to be described later) is notified of the identification number of the change target entry. When the operator presses the “Cancel” button, the change content of the target entry in the entry list display portion 910 and parameter display portion 920 is discarded, and a display switching process (to be described later) is notified of the identification number of the change target entry. At this time, whether to discard the change content of the target entry may be inquired of the operator.

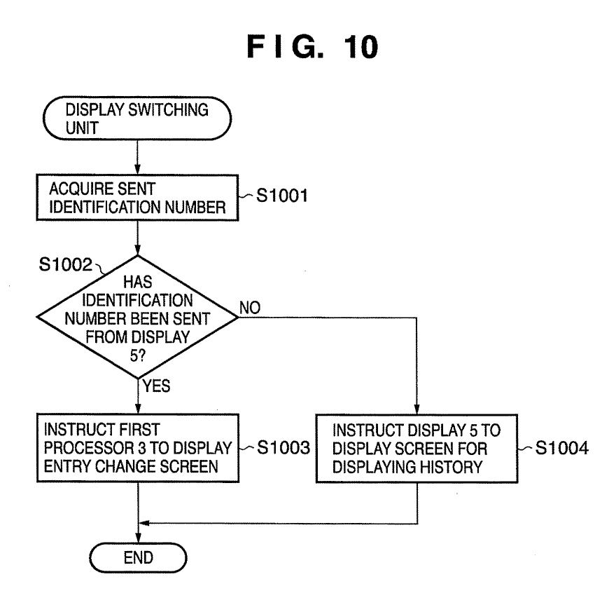

Upon receiving the notification of the identification number from the display 5 by the entry change screen and the first processor 3 by the entry display screen, the display switching unit 6 performs a display switching process of switching screens presented to the operator. The procedure of the display switching process will be explained with reference to the flowchart illustrated in FIG. 10. In step S1001, the display switching unit 6 acquires the sent identification number. In step S1002, the display switching unit 6 confirms whether the display 5 or the first processor 3 has sent the identification number. If the display 5 has sent the identification number, in step S1003 the display switching unit 6 notifies the first processor 3 of the identification number acquired in step S1001 to instruct it to display an entry change screen. On the other hand, if it is determined in step S1002 that the display 5 has not sent the identification number, in step S1004 the display switching unit 6 notifies the display 5 of the identification number acquired in step S1001 to instruct it to display a screen for displaying the history.

As has been described above, according to the second embodiment, the display 5 provides a screen for displaying the reference relation between entries and the history of changes of each entry in a tree structure. In addition, the display switching unit 6 for switching between the entry change screen for changing each entry and the screen for displaying the history is provided, thus attaining a high-operability exposure apparatus.

### Embodiment of Exposure Apparatus

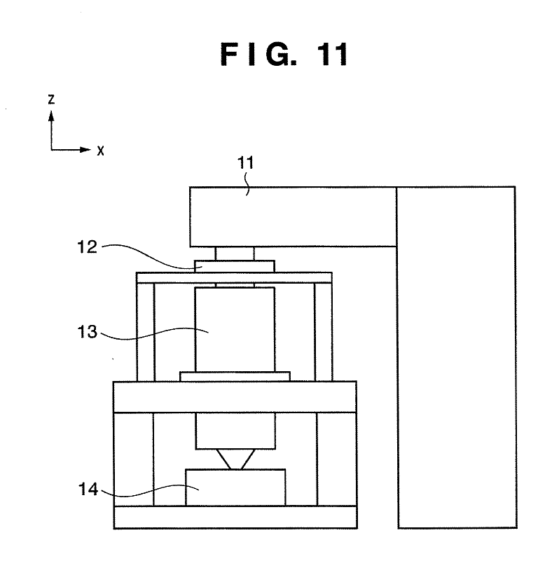

An exemplary exposure apparatus to which a recipe management apparatus according to the present invention is applied will be explained below. As shown in FIG. 11, the exposure apparatus comprises an illumination unit 11, a reticle stage 12 which mounts a reticle, a projection optical system 13, and a substrate stage 14 which mounts a substrate. The exposure apparatus projection-exposes a substrate to radiant energy so that a circuit pattern formed on a reticle is transferred onto the substrate, and may adopt the step & repeat projection exposure scheme or the step & scan projection exposure scheme.

The illumination unit 11 illuminates the reticle on which the circuit pattern is formed, and comprises a light source unit and illumination optical system. The light source unit uses, for example, a laser as a light source. The laser can be, for example, an ArF excimer laser with a wavelength of about 193 nm, a KrF excimer laser with a wavelength of about 248 nm, or an F₂ excimer laser with a wavelength of 153 nm. However, the type of laser is not particularly limited to an excimer laser. For example, the type of laser may be a YAG laser, and the number of lasers is also not particularly limited. If a laser is used as the light source, a light beam shaping optical system for shaping a parallel beam from the laser source into a desired beam shape, and an incoherent optical system for converting a coherent laser beam into an incoherent laser beam are preferably used. The light source which can be used for the light source unit is not particularly limited to a laser, and one or a plurality of lamps such as mercury lamps or xenon lamps can also be used.

The illumination optical system illuminates a mask, and includes, for example, a lens, mirror, light integrator, and stop.

The projection optical system 13 can be, for example, an optical system having only a plurality of lens elements, an optical system having a plurality of lens elements and at least one concave mirror, an optical system having a plurality of lens elements and at least one diffraction optical element, or an optical system having a total reflection mirror.

The reticle stage 12 and substrate stage 14 can be moved by, for example, linear motors. If the exposure apparatus is of the step & scan projection exposure scheme, these stages move in synchronism with each other. An actuator is separately provided to at least one of the substrate stage and the reticle stage to align the pattern of the reticle on the substrate.

Such an exposure apparatus can be used to manufacture micropatterned devices such as a semiconductor device, for example, a semiconductor integrated circuit, a micromachine, and a thin-film magnetic head.

### Embodiment of Method of Manufacturing Device

An embodiment of a method of manufacturing a device using the above-described exposure apparatus will be explained next. A device (e.g., a semiconductor integrated circuit element or liquid crystal display element) is manufactured by a step of exposing a substrate (e.g., a wafer or glass plate) coated with a photosensitive agent to radiant energy using the exposure apparatus according to any one of the above-described embodiments, a step of developing the substrate exposed in the exposing step, and other known steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-112298, filed Apr. 20, 2007, which is hereby incorporated by reference herein in its entirety.

What is claimed is:

1. An exposure apparatus for exposing a substrate to radiant energy in accordance with a recipe including a plurality of elements, the apparatus comprising:
a first storage configured to store the plurality of elements;
a first processor configured to change a content of a first element stored in the first storage; and
a second processor configured to change a content of a second element stored in the first storage, the second element referring to the first element, in accordance with the change performed for the first element.

2. An apparatus according to claim 1, further comprising a second storage configured to store a history of changes of each of the plurality of elements stored in the first storage,
wherein the first processor is further configured to change the history of changes of a third element stored in the second storage, and
the second processor is further configured to change the history of changes, stored in the second storage, of a fourth element, the fourth element referring to the third element whose history of changes is changed by the first processor.

3. An apparatus according to claim 1, wherein the second processor is configured to change, first, a fifth element which directly refers to the first element whose content is changed by the first processor, and to change, next, a sixth element which further refers to the fifth element whose content is changed by the second processor.

4. An apparatus according to claim 2, further comprising a display configured to display a history of changes of a specific element together with a reference relation between the specific element and another element and a history of changes of the other element in a tree structure.

5. An apparatus according to claim 4, wherein the display is configured to display changes in a content of the specific element differently between a change by the first processor and a change by the second processor.

6. An apparatus according to claim 4, wherein
the display is configured to provide a change process screen for changing a content and a history of changes of each of the plurality of elements, and
the apparatus further comprises a display switching unit configured to switch screens of the display between the change process screen and a screen for displaying the tree structure.

7. A method of manufacturing a device, the method comprising:
exposing a substrate to radiant energy using an exposure apparatus defined in claim 1;
developing the exposed substrate; and
processing the developed substrate to manufacture the device.
